(19) United States
(12) Patent Application Publication
(10) Pub. No.: US 2012/0265670 A1
(43) Pub. Date: Oct. 18, 2012

(54) METHOD AND SYSTEM FOR GENERATING AN INDEX OF PERFORMANCE USING NON-TRANSACTIONAL TRADE DATA

(75) Inventors: Isaac A. Abiola, New Providence, NJ (US); Paul Chin, Whippany, NJ (US)

(73) Assignee: THE DUN & BRADSTREET CORPORATION, Short Hills, NJ (US)

(21) Appl. No.: 13/343,455

(22) Filed: Jan. 4, 2012

Related U.S. Application Data
(60) Provisional application No. 61/429,625, filed on Jan. 4, 2011.

(51) Int. Cl. G06Q 40/02

(52) U.S. Cl. 705/38

(57) ABSTRACT

There is provided a method for providing an index of performance of a party. the method includes (a) generating a transactional index, (b) generating a non-transactional index, and (c) generating the index of performance based on a weighted average of the transactional index and the non-transactional index. There is also provided a system that performs the method, and a storage medium having instructions that control a processor to perform the method.

### BACKGROUND

1. Field of the Disclosure

The present disclosure relates to a technique for evaluating risk of lending money to a business. In particular, the present disclosure provides for methods and systems for generating an index of performance using non-transactional trade data.

2. Description of the Related Art

An element of many business-to-business credit transactions is the notion of determining an ability to pay an amount according to an agreed upon payment term. Whether a business entity is a startup, a longstanding business, a large corporation or a small family-owned limited liability corporation, determining a performance index, e.g., a credit risk, is a fundamental business principle in determining whether or not to do business with such business entity.

One example of an indicator of a credit risk is a Fair Isaac Corporation generated credit score from a host of detailed trade or payment experience transactional factors. The transactional factors require a transactional history between a creditor and a debtor in order to generate an accurate credit score. The Fair Isaac Corporation credit score ranges from 300-850, with a higher number representing a better credit score. However, in the absence of historical detailed trade or payment experience transaction data, this credit score may not be generated, or may lose meaningful and accurate representation.

Another method of determining a credit risk using conventional transactional data is a “Paydex Index” granted by the Dun and Bradstreet Corporation. The Dun and Bradstreet Paydex Index focuses on the promptness of payments with respect to an agreed-upon payment term. The Paydex Index ranges from 0 to 100, with 90-100 considered an excellent Paydex Index; 71-89 considered as a good Paydex Index; and 70 and below considered a bad Paydex Index. A higher numerical Paydex Index indicates a better payment performance. The Paydex Index requires a minimum of three reported transactions or payment experiences to generate an accurate index.

Despite efforts to date, a need remains for a system and method of generating an accurate performance index when limited or no transactional trade data is available. The present disclosure overcomes the aforementioned deficiencies of prior systems by providing a system and method of generating an index of performance of a party with less than three detailed trade or payment experience transactions or payment experiences by utilizing non-transactional data. These and other needs are advantageously satisfied by the disclosed systems and methods herein.

### SUMMARY

A method for generating an index of performance includes, generating a first transactional index, generating a non-transactional index, and generating the index of performance based on a weighted average of the first transactional index and the non-transactional index.

Further, in some embodiments a ⅓ weighting may be applied to the first transactional index resulting in a ⅓ weighted first transactional index, a ⅔ weighting may be applied to the non-transactional index resulting in a ⅔ weighted non-transactional index, and generating an index of performance based on a weighted average of the first transactional index and the non-transactional index may further include adding the ⅓ weighted first transactional index to the ⅔ weighted non-transactional index.

In other embodiments a second transactional index is generated. An index of performance, in such embodiments, is generated based on a weighted average of the first transactional index, the second transactional index and the non-transactional index.

Further still, in instances of two transactional indexes, i.e., a first transactional index and a second transactional index, generating the index of performance further includes adding the first transactional index to the second transactional index resulting in a total transactional index. A ⅔ weighting is applied to the total transactional index resulting in a ⅔ weighted total transactional index. Additionally, a ⅓ weighting is applied to the non-transactional index resulting in a ⅓ weighted non-transactional index. The ⅔ weighted total transactional index is added to the ⅓ weighted non-transactional index thereby generating an index of performance based on a weighted average of the first transactional index, the second transactional index and the non-transactional index.

A system is also provided that includes a processor, a memory, and a display device. The memory contains instructions that control the processor to cause the processor to perform the actions of: generating a first transactional index, generating a non-transactional index, generating the index of performance based on a weighted average of the first transactional index and the non-transactional index, and issuing a report displaying the index of performance. The display device displays the report.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a block diagram for a method for generating an index of performance.

FIG. 2 is a block diagram of a configuration of a system to generate an index of performance.

### DETAILED DESCRIPTION OF THE DISCLOSURE

In the following detailed description, reference is made to the accompanying drawings. These drawings form a part of this specification and show by way of example specific preferred embodiments in which the present disclosure may be practiced. Other embodiments may be used with logical structural changes without departing from the spirit and scope of the present disclosure. Therefore, the following detailed description is not to be taken in a limiting sense and the scope of the present disclosure is defined only by the appended claims.

The present disclosure is directed to a method of generating an index of performance using non-transactional trade data. The method provides a performance index to facilitate business transactions between otherwise financially responsible businesses with minimal transactional trade data.

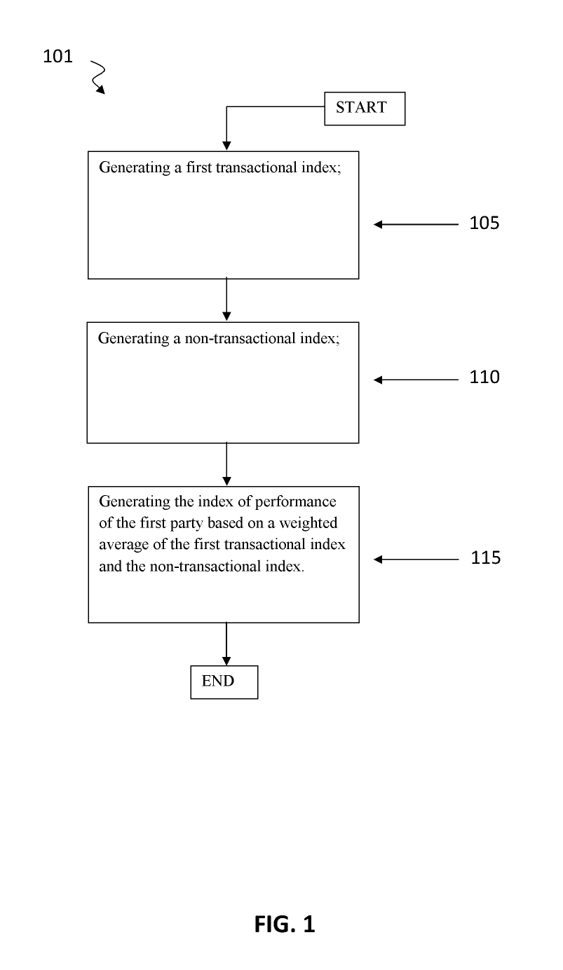

FIG. 1 is a block diagram of a method 101 for generating an index of performance using non-transactional data.

In step 105, method 101 generates a first transactional index.

In step 110, method 101 generates a non-transactional index.

In step 115, method 101 generates an index of performance of a first party based on a weighted average of the first transactional index and the non-transactional index. The index performance can be a credit index.

The first transactional index can be generated by a detailed trade or payment experience of the first party, and in particular, a detailed trade or payment experience as between the first party and a second party.

The non-transactional index is generated from at least one criteria selected from the group consisting of: size of a business, zip code commercial risk score, liens outstanding, amount of damages from judgments, amount of potential damages from pending suits, time of operation in an industry, time of incorporation and peer business' detailed trade or payment experience transaction reports.

In other embodiments, method 101 may further include displaying the index of performance on a display device.

In addition, a second transactional index may be generated. The second transactional index, similar to the first transactional index, can be generated by a second detailed trade or payment experience as between the first party and another party that may be the same entity as the second party discussed above, or a third party. The second transactional index represents a separate, or different, detailed trade or payment experience between the first party and another party.

Additionally, in further embodiments, the step for generating an index of performance may include generating the index of performance based on a weighted average of the first transactional index, the second transactional index and the non-transactional index.

In the embodiments where there is provided a single transactional index, i.e., a first transactional index, and a non-transactional index, generating an index of performance can incorporate different weighting for the first transactional index and the non-transactional index. Preferably, the first transactional index is weighted by ⅓ and the non-transactional index is weighted by ⅔. The performance index then results from adding the ⅓ weighted first transactional index to the ⅔ weighted non-transactional index. This example, using a first transactional index and non-transactional index with associated weighting therewith, is provided below:

### Quantity of Transactional Trade Data=1,

Performance Index=W1 (first transactional index)+W2 (non-transactional index)

Wherein: W1=⅓ and W2=⅔

Accordingly, if the first transactional index is 70 and the non-transactional index is 80 then the Performance Index=(0.33)(70)+(0.670(80)=77.

In embodiments whereby there are two transactional indices, i.e., a first transactional index and a second transactional index, a different weighting can be used. Preferably, the two transactional indices are added together resulting in a total transactional index. The total transactional index is then weighted by ⅔. The remaining non-transactional index is weighted by ⅓. Each index, i.e., the first transactional index, the second transactional index and the non-transactional index, can be weighted such that a generated performance index does not exceed 100. For example:

$$Quantity of Transactional Trade Data = 2$$

$$Performance Index = W 1 ( first transactional index + second transactional index ) + W 2 ( non \text{-} transactional index )$$

$$Wherein \text{:} W 1 = 2 / 3 and W 2 = 1 / 3$$

Accordingly, if the total transactional index is 90 and the non-transactional index is 80 then the Performance Index=0.67*90+0.33*80=87.

Further, in method 101, the non-transactional index is based on a group of non-detailed trade or payment experience transactional data. Each of the criteria listed within the group can be assigned a numerical value. In particular, the size of a business can include a scaling from 1 to 5, where 1 represents the smallest business and 5 represents the largest business.

An aggregate zip code level commercial risk identifies a zip code in which a business is registered to do business. Cumulatively, businesses within a particular zip code have an associated credit risk associated with them. The zip code level commercial risk score aggregates the credit risk associated with businesses within a particular zip code resulting in a zip code level commercial risk score such as, but not limited to, a TransUnion Aggregate Zip Code Level Commercial Risk Score.

Further, an amount of damages from judgments describes any legally binding obligation to pay damages as determined by a court of law. Damages from judgments are also assigned a numerical value that corresponds with the size of damages. A larger judgment corresponds with a higher numerical index.

Likewise, an amount of potential damages from pending suits describes any potentially binding legal obligation to pay damages as determined by a court of law. Potential damages may also be assigned a numerical value corresponding with the size.

A time of operation in an industry is another factor considered in determining the non-transactional index. The time of operation in an industry represents the amount of time, in years, that a party has been in a particular industry. A numerical value is assigned for the time of operation in an industry. The numerical value assigned increases with the greater amount of time the party has been in operation in an industry.

The time of incorporation, like the time of operation in an industry, is a measure, in years, of the amount of time a party has been incorporated and is also assigned a numerical value.

The peer business' detailed trade or payment experience transaction reports evaluates the first party to a peer group of businesses, each of which has detailed transaction reports. The peer business' detailed trade or payment experience transaction reports contain an amount, a payment term, and transactional trade data representing the timeliness of payments. In this fashion, the peer business' detailed trade or payment experience transaction reports may be used as a proxy for a transactional index.

Preferably, the first transactional index is a numerical value ranging from 0-100, inclusive, and corresponds to the timeliness of payment according to a payment term. A higher index is associated with timely payments, on or before an agreed upon payment term. In particular, earlier payments result in a higher first transactional index, but not to exceed 100. As such, the first transaction index can be generated from a payment term.

For example, the first party and a second party may contract to an agreed upon payment term having an agreed upon first number of days and corresponding first payment amount. The first transaction index can be generated by comparing (a) the number of days until an occurrence of the payment of the first payment amount to (b) the agreed upon payment term. For example, a first transactional index of 80 corresponds to on-time payment. That is, payment of the first amount occurred on the due date of the agreed upon payment term. Likewise, if payment of the first amount occurs before the expiration of the agreed upon first number of days, then the first transactional index will be assigned a numerical value higher than 80. Payment post expiration of the first number of days of the payment term, however, results in a decreased transactional index for subsequent late payment.

Similarly, a second transactional index, when provided, corresponds to timeliness of payment according to another payment term. The second payment term can also include an agreed upon a second number of days until payment of a second amount is due between the first party and a third party. The second transactional index is generated by comparing (a) the amount of days until a occurrence of a payment of the second amount to (b) the corresponding days in the agreed upon second payment term. Preferably, a numerical value from 0-100 is also assigned to the second transactional index with a higher index associated with timely payments on or before an agreed upon payment term. If the second amount is paid on time, e.g., on the expiration day the second payment term, the second transactional index will be assigned a value of 80. Additionally, if the of the second payment amount occurs before the expiration of the agreed second number of days, the second transactional index will be assigned a numerical value higher than 80. The earlier the payment, the higher the numerical value assigned. Payment post expiration of the agreed number of days, i.e., late payments, will result in an index with a numerical value less than 80 with a decreasing numerical value assigned for later payments.

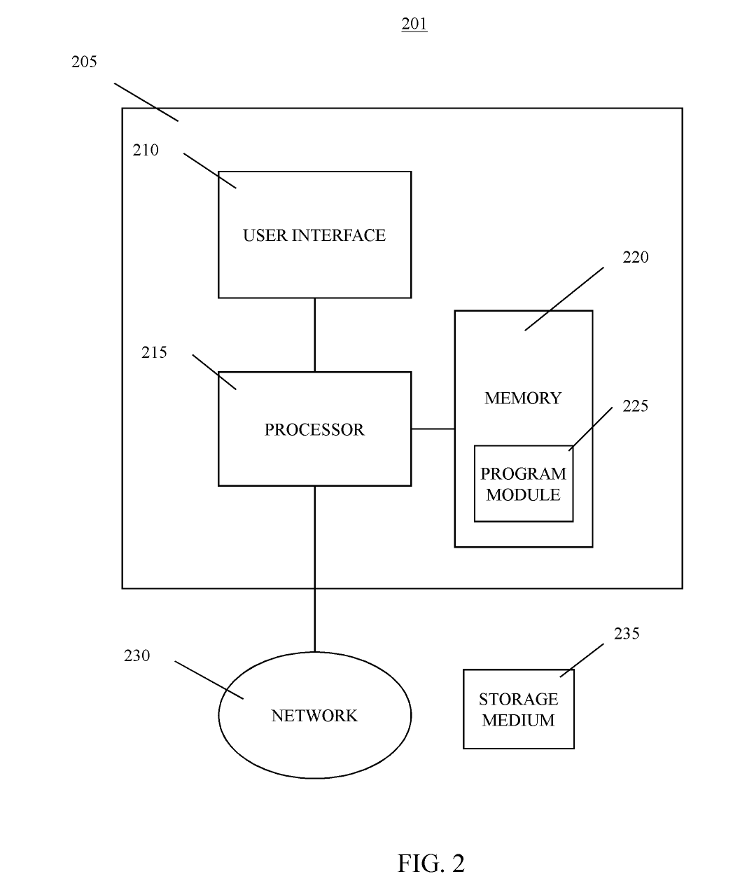

FIG. 2 is a block diagram of a system 200 for employment of the present invention. System 200 includes a computer 205 coupled to a network 230, e.g., the Internet.

Computer 205 includes a user interface 210, a processor 215, and a memory 220. Although computer 205 is represented herein as a standalone device, it is not limited to such, but instead can be coupled to other devices (not shown) in a distributed processing system.

User interface 210 includes an input device, such as a keyboard or speech recognition subsystem, for enabling a user to communicate information and command selections to processor 215. User interface 210 also includes an output device such as a display or a printer. A cursor control such as a mouse, track-ball, or joy stick, allows the user to manipulate a cursor on the display for communicating additional information and command selections to processor 215.

Processor 215 is an electronic device configured of logic circuitry that responds to and executes instructions.

Memory 220 is a tangible computer-readable medium encoded with a computer program. In this regard, memory 220 stores data and instructions that are readable and executable by processor 215 for controlling the operation of processor 215. Memory 220 may be implemented in a random access memory (RAM), a hard drive, a read only memory (ROM), or a combination thereof. One of the components of memory 220 is a program module 225. Program module 225 contains instructions for controlling processor 215 to execute the methods described herein. For example, under control of program module 225, processor 215 performs the actions of generating a first transactional index, generating a non-transactional index, generating an index of performance of a first party based on a weighted average of the first transactional index and the non-transactional index, and issuing a report displaying the index of performance, wherein the display device, such as user interface 210, displays the report.

Preferably, the first transactional index is generated from a first detailed trade or payment experience transaction of the first part and the non-transactional index is generated from at least one criteria selected from the group consisting of: size of a business, zip code commercial risk score, liens outstanding, amount of damages from judgments, amount of potential damages from pending suits, time of operation in an industry, time of incorporation, and peer business' detailed trade or payment experience transaction reports.

In other embodiments processor 215 performs the action of generating a second transactional index. In such embodiments, processor 215 generates the index of performance based on a weighted average of the first transactional index, the second transactional index and the non-transactional index.

Further, similarly to the weighting used in method 101, system 201, via processor 215, applies a weighting to the transactional indices and the non-transactional index. Similarly to the weighting din method 101, for embodiments with a single transactional index, i.e., a first transactional index, and a non-transactional index, processor 215 will apply a ⅓ weighting to the single transactional index and a ⅔ weighting to the non-transactional index. Processor 215 further adds the ⅓ weighted single transactional index to the ⅔ non-transactional index to generate an index of performance.

In embodiments with two transactional indices, i.e., a first transactional index and a second transactional index, and a non-transactional index, processor 215 will apply a different weighting. Processor 215 will add the two transactional indices resulting in a total transactional index and apply a ⅔ weighting to the total transactional index. Processor 215 will further apply a ⅓ weighting to the non-transactional index. Processor 215 will generate an index of performance based on the weighted total transactional index and the weighted non-transactional index.

The term “module” is used herein to denote a functional operation that may be embodied either as a stand-alone component or as an integrated configuration of a plurality of sub-ordinate components. Thus, program module 225 may be implemented as a single module or as a plurality of modules that operate in cooperation with one another. Moreover, although program module 225 is described herein as being installed in memory 220, and therefore being implemented in software, it could be implemented in any of hardware (e.g., electronic circuitry), firmware, software, or a combination thereof.

Processor 215 outputs, to user interface 210, a result of an execution of the above actions such as a report illustrating the performance index described herein. Alternatively, processor 215 could direct the output to a remote device (not shown) via network 230.

While program module 225 is indicated as already loaded into memory 220, it may be configured on a storage medium 235 for subsequent loading into memory 220. Storage medium 235 is also a tangible computer-readable medium encoded with a computer program, and can be any conventional storage medium that stores program module 225 thereon in tangible form. Examples of storage medium 235 include a floppy disk, a compact disk, a magnetic tape, a read only memory, an optical storage media, universal serial bus (USB) flash drive, a digital versatile disc, or a zip drive. Alternatively, storage medium 235 can be a random access memory, or other type of electronic storage, located on a remote storage system and coupled to computer 205 via network 230.

Preferably, the first transactional index in system 201 is analogous to the first transactional index in method 101. As such, the discussion in method 101 relating to generation of the first transactional index according to a payment term is equally applicable in system 201. Likewise, the second transactional index in system 201 is analogous to the second transactional index in method 101. Accordingly, the discussion in method 101 relating to generation of the second transactional index according to a second payment term is equally applicable in system 201.

It is to be understood that the above description is intended to be illustrative and not restrictive. Many other embodiments will be apparent to those of skill in the art upon reviewing the above description. Therefore, the scope of the present invention should be determined with reference to the appended claims, along with the full scope of equivalents to which such claims are entitled.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method for providing an index of performance of a party, said method comprising:
generating a transactional index;
generating a non-transactional index; and
generating said index of performance based on a weighted average of said transactional index and said non-transactional index.

2. The method of claim 1, wherein said generating said index of performance comprises:
applying a ⅓ weighting to said transactional index, resulting in a weighted transactional index;
applying a ⅔ weighting to said non-transactional index, resulting in a weighted non-transactional index; and
adding said weighed transactional index to said weighted non-transactional index.

3. The method of claim 1,
wherein said transactional index is a first transactional index,
wherein said method further comprises generating a second transactional index, and
wherein said index of performance is based on a weighted average of said first transactional index, said second transactional index, and said non-transactional index.

4. The method of claim 1,
wherein said transactional index is a first transactional index,
wherein said method further comprises generating a second transactional index, and
wherein said generating said index of performance comprises:
adding said first transactional index to said second transactional index, resulting in a total transactional index;
applying a ⅔ weighting to said total transactional index, resulting in a weighted total transactional index;
applying a ⅓ weighting to said non-transactional index, resulting in a weighted non-transactional index; and
adding said weighed total transactional index to said weighted non-transactional index.

5. The method of claim 1,
wherein said transactional index is a first transactional index,
wherein said method further comprises generating a second transactional index,
wherein said first transactional index is generated from a first detailed trade or payment experience transaction of said first party, and
wherein said second transactional index is generated from a second detailed trade or payment experience transaction of said first party.

6. The method of claim 1, wherein said transactional index is generated from (a) a payment term having an agreed upon number of days and a payment amount, compared to (b) a number of days until an occurrence of a payment of said payment amount.

7. The method of claim 1, wherein said non-transactional index is based on at least one criteria selected from the group consisting of: size of a business, zip code commercial risk score, liens outstanding, amount of damages from judgments, amount of potential damages from pending suits, time of operation in an industry, time of incorporation, and peer business' detailed trade or payment experience transaction reports.

8. The method of claim 1, wherein said index of performance is a credit risk score.

9. The method of claim 1, further comprising:
displaying said index of performance on a display device.

10. A system comprising:
a processor;
a memory that contains instructions that control said processor to:
generate a transactional index;
generate a non-transactional index;
generate an index of performance of a party based on a weighted average of said transactional index and said non-transactional index; and
issue a report of said index of performance; and
a display device that displays said report.

11. The system of claim 10, wherein said instructions, to control said processor to generate said index of performance, control said processor to:
apply a ⅓ weighting to said transactional index, resulting in a weighted first transactional index;
apply a ⅔ weighting to said non-transactional index, resulting in a weighted non-transactional index; and
add said weighed transactional index to said weighted non-transactional index.

12. The system of claim 10,
wherein said transactional index is a first transactional index,
wherein said instructions also control said processor to generate a second transactional index, and
wherein said index of performance is based on a weighted average of said first transactional index, said second transactional index, and said non-transactional index.

13. The system of claim 10,
wherein said transactional index is a first transactional index,
wherein said instructions also control said processor to perform an action of generating a second transactional index, and
wherein said instructions, to control said processor to generate said index of performance, control said processor to:
add said first transactional index to said second transactional index, resulting in a total transactional index;
apply a ⅔ weighting to said total transactional index, resulting in a weighted total transactional index;
apply a ⅓ weighting to said non-transactional index, resulting in a weighted non-transactional index; and
add said weighed total transactional index to said weighted non-transactional index.

14. The system of claim 10,
wherein said transactional index is a first transactional index,
wherein said instructions also control said processor to perform an action of generating a second transactional index,
wherein said first transactional index is generated from a first detailed trade or payment experience transaction of said first party, and
wherein said second transactional index is generated from a second detailed trade or payment experience transaction of said first party.

15. The method of claim 10, wherein said processor generates said transactional index from (a) a payment term having an agreed upon number of days and a payment amount, compared to (b) a number of days until an occurrence of a payment of said payment amount.

16. The system of claim 10, wherein said processor generates said non-transactional index from at least one criteria selected from the group consisting of: size of a business, zip code commercial risk score, liens outstanding, amount of damages from judgments, amount of potential damages from pending suits, time of operation in an industry, time of incorporation, and peer business' detailed trade or payment experience transaction reports.

17. A storage medium that is tangible and computer-readable, comprising instructions that, when read by a processor, control said processor to:
generate a transactional index;
generate a non-transactional index;
generate an index of performance of a party based on a weighted average of said transactional index and said non-transactional index; and
issue a report of said index of performance

18. The storage medium of claim 17, wherein said instructions, to control said processor to generate said index of performance, control said processor to:
apply a ⅓ weighting to said transactional index, resulting in a weighted first transactional index;
apply a ⅔ weighting to said non-transactional index, resulting in a weighted non-transactional index; and
add said weighed transactional index to said weighted non-transactional index.

19. The storage medium of claim 17,
wherein said transactional index is a first transactional index,
wherein said instructions also control said processor to generate a second transactional index, and
wherein said index of performance is based on a weighted average of said first transactional index, said second transactional index, and said non-transactional index.

20. The storage medium of claim 17,
wherein said transactional index is a first transactional index,
wherein said instructions also control said processor to perform an action of generating a second transactional index, and
wherein said instructions, to control said processor to generate said index of performance, control said processor to:
add said first transactional index to said second transactional index, resulting in a total transactional index;
apply a ⅔ weighting to said total transactional index, resulting in a weighted total transactional index;
apply a ⅓ weighting to said non-transactional index, resulting in a weighted non-transactional index; and
add said weighed total transactional index to said weighted non-transactional index.
